(19) United States
(12) Patent Application Publication
(10) Pub. No.: US 2009/0146513 A1
(43) Pub. Date: Jun. 11, 2009

(54) ROTARY ELECTRIC MACHINE STATOR ASSEMBLY DESIGN AND MANUFACTURING METHOD

(76) Inventor: Ronald Dean Bremner, Cedar Falls, IA (US)

Correspondence Address: DEERE & COMPANY, ONE JOHN DEERE PLACE, MOLINE, IL, 61265, US

(21) Appl. No.: 11/950,593

(22) Filed: Dec. 5, 2007

(51) Int. Cl. H02K 1/16; H02K 3/34; H02K 15/085; H02K 15/02; H02K 9/22

(52) U.S. Cl. 310/64; 310/215; 29/596

(57) ABSTRACT

The invention relates to a design for and a method of manufacturing a rotary electric machine stator assembly. There is a need for improved cooling in rotary electric machines, such as motors and generators. A stator assembly is provided for a rotary electric machine having a rotor which rotates within a stator which is enclosed within a cooling jacket. The stator has a plurality of grooves separated by a plurality of stator teeth. A stator coil is wrapped around each corresponding tooth. The stator assembly also includes a plurality of heat conducting plates which conduct heat from a coil to the stator. In one embodiment, adjacent pairs of coils are separated by one of a plurality of radially and axially extending slots, and the plates are received within the slots. In another embodiment, the plates are positioned between the stator coil and each side of the corresponding tooth around which the coil is wrapped.

### FIELD OF THE INVENTION

The present invention relates to a rotary electric machine stator assembly design and method of manufacturing the same.

### BACKGROUND OF THE INVENTION

All rotary electric machines, such as motors and generators, generate heat because of the electrical resistance of the coils. Heat is also generated in the stator laminations because of magnetic hysteresis and eddy currents. The heat generated in the coils typically passes through the stator to the housing. The housing then removes this heat by convection to air or liquid. Some of the heat is also conducted to the frame, and in some cases heat is removed by radiation. In some cases, oil is sprayed on the end windings, or flows past the end windings, to conduct heat away. The heat generated in the stators flows through the stator steel, and into the housing. Sometimes, channels (which are punched into the stator) also conduct heat away from the stator by convection.

Some stators are wound by hand, which results in a high concentration of copper in the coils. This allows better heat transfer to the stator. Other stators are wound as concentrated segments by machine. In these stators, a gap is left for the needle of the winding machine. In many machines, the stator is potted with a type of plastic which has better thermal conductivity than air, but less than metals. In these machines, the gap is filled with plastic, and the plastic in the gap will not efficiently conduct heat from the coil to the stator.

### SUMMARY OF THE INVENTION

Accordingly, an object of this invention is to provide a rotary electric machine with a stator assembly which efficiently conducts heat away from the coils.

Another object of this invention is to provide a method of making such a rotary electric machine.

These and other objects are achieved by the present invention, wherein a stator assembly is provided for a rotary electric machine having a rotor which rotates within a stator which is enclosed within a cooling jacket. The stator has a hollow stator body enclosed within a cooling jacket, and a plurality of stator teeth which project radially inwardly from the stator body. The teeth are separated by a plurality of grooves. A stator coil is wrapped around each corresponding tooth. The stator assembly also includes a plurality of heat conducting plates which conduct heat from a coil to the stator. In one embodiment, adjacent pairs of coils are separated by one of a plurality of radially and axially extending slots, and the plates are received within the slots. In another embodiment, the plates are positioned between the stator coil and each side of the corresponding tooth around which the coil is wrapped.

### BRIEF DESCRIPTION OF THE DRAWINGS

FIG. 1 is a perspective sectional view of an electric machine embodying the invention;

FIG. 2 is a view of the stator unit taken along lines 2-2 of FIG. 1;

FIG. 3 is an enlarged view of a portion of FIG. 2; and

FIG. 4 is an enlarged view similar to FIG. 3 of an alternative embodiment.

### DESCRIPTION OF THE PREFERRED EMBODIMENT

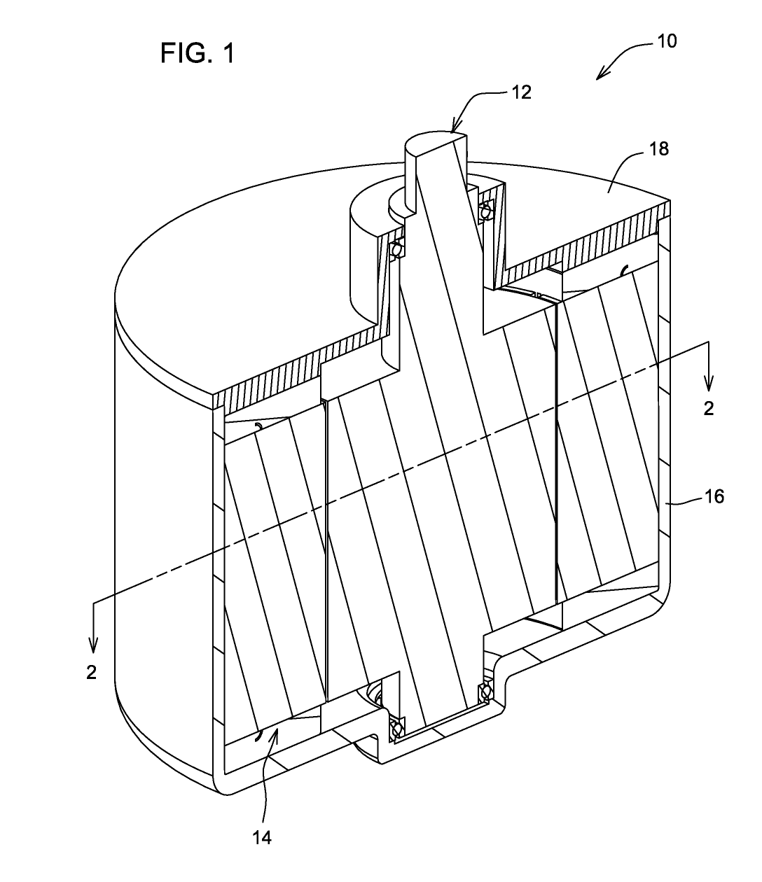

Referring to FIG. 1, an electric machine 10 includes a rotor unit 12 which rotates within a stator unit 14. The rotor unit 12 and stator unit 14 are enclosed by a cooling jacket or housing 16 and an end cap 18.

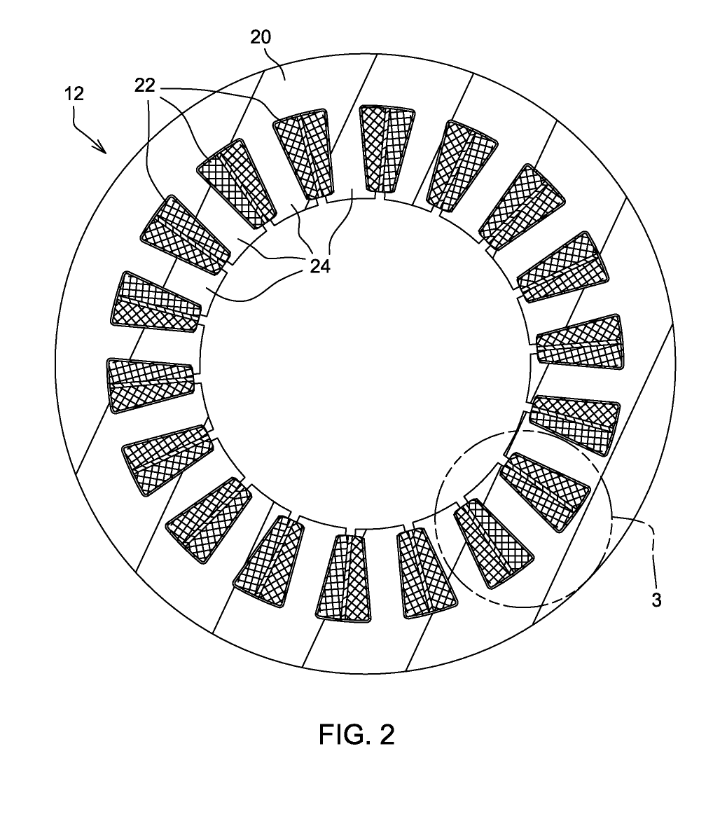

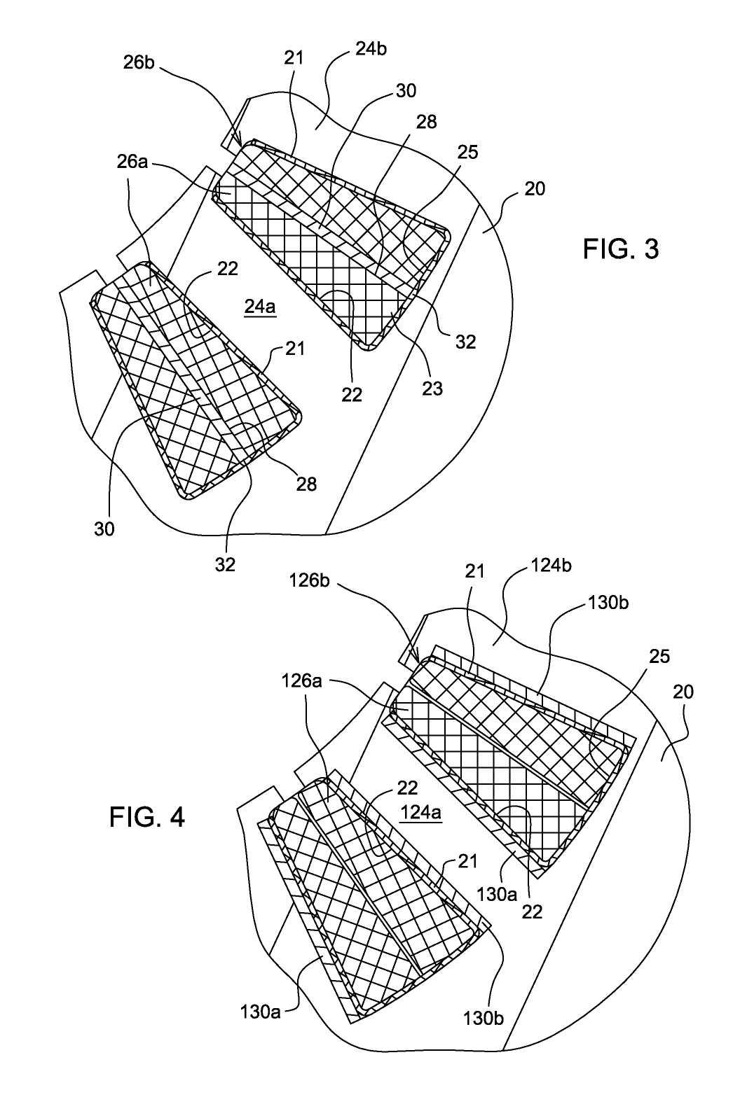

As best seen in FIGS. 2 and 3, the stator unit 12 includes a conventional stator body 20, preferably comprising a plurality of stator laminations. The stator body 20 includes a plurality of radially inwardly projecting stator teeth 24 separated by a corresponding plurality of axially extending grooves 22. A plurality of axially extending grooves 22 are formed in the stator body 20, and the grooves are separated by radially inwardly projecting stator teeth 24. Each groove 22 has a radially outward end 23 defined by a radially inwardly facing groove wall 25 formed by the stator 20. Each groove 22 is lined or coated with an electric insulating groove liner 21.

A stator coil 26a is wrapped around tooth 24a and stator coil 26b is wrapped around tooth 24b. Adjacent coils 26a and 26b are separated by an axially and radially extending gap or slot 28. The gap 28 is normally caused by the needle of the coil winding machine (not shown). A heat conducting plate 30 or strip is received in each gap 28. The plate 30 is preferably aluminum or copper, and is inserted in the gap 28 after the coils 26 are wound. The plate 30 may be coated with an electrical insulating material before it is inserted into the gap 28. Then, the stator 14 would be potted. The plate or strip 30 conducts heat from the coils 26 to the radially outward end 32 of the gap 28. The heat is then conducted through the stator 20 to the cooling jacket 16.

Referring now to FIG. 4, an alternate embodiment is shown wherein there is no or a minimal gap between coils 126a and 126b, such as when the coils are hand-wound around teeth 124a and 124b. In this embodiment, heat conductive plates 130a and 130b are placed against both sides of the stator grooves 22. Then an electric insulating groove liner 21 is placed in each groove 22 with opposite sides next to the plates on opposite sides of each groove 22. Then, a corresponding coil 126a is wound around each corresponding tooth 124a. More particularly, a first plate 130a is located between the stator coil 126a and a first side of the corresponding tooth 124a, and a second plate 130b is located between the stator coil 126a and a second side of the corresponding tooth 124a. The plates 130a and 130b are outside of the insulators 21, and the plates conduct heat radially outwardly to the stator body 20. Each plate 130a and 132b may have an adhesive on it, to bond it to the side of the groove 22. Alternatively, the plates 130a and 130b could be placed inside the insulators 21, in which case they would conduct heat axially to the stator body 20 at the bottom (not shown) of the grooves 22.

In a third embodiment (not shown), for all stators which are potted, a plate of heat conductive material with a thin layer of electrically insulated material would be placed on the end of the end windings, before potting of the stator. The plate would contact, or nearly contact the cooling jacket walls, or end housing. The stator would then be potted. The material would conduct heat from the end windings to the cooling jacket.

With this design a electric machine can generate more torque or power for the same amount of temperature rise in the machine. This makes possible a smaller, less expensive machine. Or, machines of equivalent size will be more efficient.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A rotary electric machine comprising:
a stator having a hollow stator body and a plurality of stator teeth projecting radially inwardly from the stator body, said teeth being separated by a plurality of grooves;
a plurality of stator coils, each stator coil being wrapped around a corresponding tooth;
an electric insulating groove liner interposed between each coil and adjacent stator teeth and body surfaces; and
a plurality of heat conducting plates, each plate conducting heat from at least one of the coils to the stator body; and
a rotor rotatable within the stator.

2. The rotary electric machine of claim 1, wherein:
adjacent pairs of coils are separated by one of a plurality of radially and axially extending slots; and
each plate is received within a corresponding one of the slots.

3. The rotary electric machine of claim 1, wherein:
each groove has a radially outer end defined by a radially inwardly facing groove wall formed by the stator body;
each plate engages a corresponding one of the radially inwardly facing groove walls.

4. The rotary electric machine of claim 1, wherein:
each plate is located between a portion of one of the stator coils and the corresponding tooth around which said coil is wrapped.

5. The rotary electric machine of claim 1, wherein:
a first plate is received between the stator coil and a first side of the corresponding tooth around which said coil is wrapped; and
a second plate is received between the stator coil and a second side of the corresponding tooth around which said coil is wrapped.

6. The rotary electric machine of claim 5, wherein:
an electrical insulator member is placed in each groove, and each plate is positioned between a portion of said insulator member and a side of the corresponding tooth around which said coil is wrapped.

7. The rotary electric machine of claim 1, wherein:
each plate conducts heat from two of the coils to the stator.

8. A stator assembly for a rotary electric machine, the stator assembly comprising:
a stator having a hollow stator body and a plurality of stator teeth projecting radially inwardly from the stator body, said teeth being separated by a plurality of grooves
a plurality of stator coils, each stator coil being wrapped around a corresponding stator tooth; and
a plurality of heat conducting plates received in the grooves, each plate conducting heat from at least one of the coils to the stator body.

9. The stator assembly of claim 8, wherein:
adjacent coils are separated by a radially and axially extending slot; and
each plate is received within a corresponding one of the slots.

10. The stator assembly of claim 9, wherein:
each plate conducts heat to a radially inwardly facing groove wall.

11. The stator assembly of claim 8, wherein:
an electric insulating groove liner is interposed between each coil and adjacent stator surfaces; and
each plate conducts heat through a corresponding groove liner to a radially inwardly facing groove wall.

12. The stator assembly of claim 8, wherein:
each plate is located between the stator coil and the corresponding tooth around which said coil is wrapped.

13. The stator assembly of claim 8, wherein:
a first plate is received between the stator coil and a first side of the corresponding tooth around which said coil is wrapped; and
a second plate is received between the stator coil and a second side of the corresponding tooth around which said coil is wrapped.

14. The stator assembly of claim 12, wherein:
an electrical insulator member is placed in each groove, and each plate is positioned between a portion of said insulator member and a side of the corresponding tooth around which said coil is wrapped.

15. A method of making a rotary electric machine having a stator and a rotor, the method comprising:
forming a stator having a plurality of stator teeth separated by grooves;
placing a heat conducting electrically insulating groove liner in each groove, each liner having a pair of side walls, each side wall engaging one the stator teeth;
wrapping a stator coil around each tooth and the groove liner side walls, adjacent coils being separated by a radially extending slot;
placing a plurality of heat conducting plates in the grooves, each plate being received in a corresponding one of the slots, so that each plate conducts heat through a groove liner to a bottom wall of the groove;
enclosing the stator within a cooling jacket; and
mounting a rotor for rotation within the stator.

16. A method of making a rotary electric machine having a stator and a rotor, the method comprising:
forming a stator having a plurality of stator teeth separated by grooves;
placing a plurality of heat conducting plates in the grooves, each plate being in heat conducting contact with one of the stator teeth;
placing a heat conducting electrically insulating groove liner in each slot, each liner having side walls engaging the plates;
wrapping a stator coil around each tooth, a pair of the plates and a pair of the groove liner side walls;
enclosing the stator within a cooling jacket; and
mounting a rotor for rotation within the stator.

17. The method of claim 16, wherein:
each plate conducts heat directly to a radially inwardly facing groove wall.
